(19) United States
(12) Patent Application Publication
(10) Pub. No.: US 2026/0110239 A1
(43) Pub. Date: Apr. 23, 2026

(54) REDUNDANT SEAL ASSEMBLY

(71) Applicant: Silverwell Technology Limited, Cambridge (GB)

(72) Inventor: Joel David Shaw, Houston, TX (US)

(73) Assignee: Silverwell Technology Limited, Cambridge (GB)

(21) Appl. No.: 19/358,546

(22) Filed: Oct. 15, 2025

Related U.S. Application Data
(60) Provisional application No. 63/708,363, filed on Oct. 17, 2024.

(51) Int. Cl. E21B 43/12; F16K 1/38; F16K 1/46; F16K 15/02

(52) U.S. Cl. CPC E21B 43/123; F16K 1/38; F16K 1/46; F16K 15/026

(57) ABSTRACT

A valve assembly includes a valve seat, a valve member, a compliant seal assembly, and a non-compliant seal assembly. The compliant seal assembly includes an elastomeric seal member mounted to the valve seat or valve member, compressing the elastomeric seal member between the valve seat and valve member blocks flow between the valve seat and valve member. A gap remains between the valve seat and valve member when the elastomeric seal member is compressed. The non-compliant seal assembly includes opposing seal faces on the valve seat and valve member, the non-compliant seal assembly is activated by contacting the seal faces and biasing the seal faces together to elastically deform the seal faces. When the compliant seal assembly is activated, there is no gap between the valve seat and valve member, and the elastomeric seal member is fully compressed or removed.

### CROSS-REFERENCE TO RELATED APPLICATION

This application claims priority from and the benefit of co-pending U.S. Provisional Application Ser. No. 63/708,363, filed Oct. 17, 2024, the full disclosure of which is incorporated by reference herein in its entirety and for all purposes.

### BACKGROUND OF THE INVENTION

### 1. Field of Invention

The present disclosure relates to an integrated sealing assembly configured for multiple applications.

### 2. Description of Prior Art

Valves for controlling fluid flow through conduit, such as gate valves, ball valves, and check valves, typically include seals to avoid leakage when closed. Most seals are either metal-to-metal (“MTM”) or compliant type seals that typically include an elastomer that is compressed between valve members when the valve is closed. The type of seal employed is often dictated by the valve's intended service and/or local regulations.

A MTM type seal is formed by a valve seat and a valve member into contact with one another so that the surfaces on the valve seat and valve member contact one another to form a fluid barrier. The surfaces on the valve member and valve seat in contact with one another are typically referred to as seal faces and that undergo elastic deformation when forming the fluid barrier. Often, these seal faces are polished to designated surface finish. While MTM seals can provide a strong and robust seal over time, the metal components often have a high modulus that provides little deflection, which makes MTM seals susceptible to geometric discontinuities, such as from debris, manufacturing defects, erosion, wear, etc. Additionally, MTM seals are usually not bubble tight.

Compliant seals are usually formed from an elastomer or thermoplastic material that is set on, or in a recess on, the valve member or valve seat; and usually form a bubble tight seal and can be unaffected by debris within the sealing interface. Compliant seals though have operational pressure and temperature limits less than MTM seals, making them more susceptible to wear and deterioration; and can be unseated or extruded when subjected to certain pressure differentials or flow rates. A need exists for valve seals that are durable and function over a protracted period of time, especially for seals on valves that are difficult to maintain or replace.

### SUMMARY OF THE INVENTION

Disclosed herein is an example of a valve assembly for handling fluid flow and that includes a valve seat having a valve seat seal face, a valve member, a pliable ring that when compressed between the valve seat and valve member forms a compliant seal assembly that is a barrier to fluid flow through the valve assembly, a valve member seal face that when in compressive contact with the valve seat seal face forms a non-compliant seal assembly that is a barrier to fluid flow through the valve assembly, and a valve body in which the valve member and valve seat are disposed. The ring is optionally disposed in an annular recess formed on the valve body, where the recess has an inner sidewall, an outer sidewall, and a rearward wall extending radially between rearward terminal ends of the inner and outer sidewalls, alternatively, an inner radius of the pliable ring is adjacent to and moveable with respect to the inner sidewall, an outer radius of the pliable ring is adjacent to and moveable with respect to the outer sidewall, and where a rearward surface of the pliable ring is bonded to the rearward wall. An optional chamfer is on a radial edge of a forward surface of the pliable ring. In an embodiment, the pliable ring is made of an elastomer with a modulus of elasticity of up to about 0.1 GPa and the seal faces have polished metal having a modulus of elasticity that ranges from about 35 GPa to about 700 Gpa. In an example, the valve member is a plug that is biased towards the valve seat by a spring. In embodiments, the valve assembly is changeable between an open mode, a first closed mode, and a second closed mode, when in the open mode a gap is between the valve member and valve seat that defines a flow path, when in the first closed mode the pliable ring is compressed between the valve seat and valve member and the valve member seal face is spaced away from the valve seat seal face, and when in the second closed mode the valve member seal face is compressed against the valve seat seal face, and alternatively, when in the first closed mode a seal is formed between the valve member and valve seat that is bubble tight. In one embodiment, the valve body is connected between a surface controlled flow control valve and production tubing that are disposed in a wellbore.

Another example of a valve assembly for handling fluid flow includes a valve seat having a valve seat seal face, a valve member having a valve member seal face, a compliant seal formed between the valve seat and valve member when the valve seat and valve member are at a designated distance from one another, a non-compliant seal formed between the valve seat and valve member when the seal faces are in contact with one another, and a valve body in which the valve member and valve seat are disposed. Examples of the compliant seal include a ring mounted to one of the valve seat or valve member, and the ring is formed from a that is material elastically compressive. In an alternative, the ring is in an annular recess formed on the valve member, a forward surface of the ring projects past a front surface of the valve member, and a chamfer is formed along an edge of the forward surface to define a space that receives a portion of the ring when the ring is compressed. In an example, the non-compliant seal is a metal-to-metal (“MTM”) seal. In another example, the valve assembly is a check valve connected between a surface controlled flow control valve and production tubing that are disposed in a wellbore, and the surface controlled flow control valve is part of a lift gas system.

A method of handling fluid flow is disclosed that includes obtaining a valve assembly made up of a valve body, a valve member, a valve seat, a compliant seal assembly, and a non-compliant seal assembly. The example method further includes arranging the valve assembly into an open mode by creating a gap between the valve body and valve member, which forms a fluid flow path between the valve body and valve member and allows fluid to flow through the valve assembly, arranging the valve assembly into a first closed mode by urging the valve body and valve member to a distance from one another that compresses and elastically deforms the compliant seal assembly between the valve body and valve member, and arranging the valve assembly into a second closed mode by urging the valve body and valve member against one another that compresses and elastically deforms seal faces formed on the valve body and the valve member. In an example, the step of arranging the valve assembly into the first closed mode occurs for a period of time, and the step of arranging the valve assembly into the second closed mode occurs after the period of time, and during the period of time particles are included with the fluid flowing through the valve assembly. Examples of the compliant seal include an elastomeric ring mounted to the valve member and the non-compliant seal has polished seal faces on opposing surfaces of the valve member and valve seat. Alternatively, fluid leakage through the valve assembly is blocked by the compliant seal for the period of time, and fluid leakage through the valve assembly is blocked by the non-compliant seal after the period of time.

### BRIEF DESCRIPTION OF DRAWINGS

Some of the features and benefits of the present invention having been stated, others will become apparent as the description proceeds when taken in conjunction with the accompanying drawings, in which:

FIG. 1 is a side sectional view of an example of a valve assembly in an open mode.

FIG. 2 is a side sectional enlarged view of a portion of the valve assembly of FIG. 1.

FIG. 3 is a side sectional view of an example of the valve assembly of FIG. 1 in a closed mode.

FIG. 4A is a side sectional enlarged view of a portion of the valve assembly of FIG. 3 having a compliant seal.

FIG. 4B is a side sectional enlarged view of a portion of the valve assembly of FIG. 3 having a metal-to-metal seal.

FIG. 5 is a side partial sectional view of an example of a well system having the valve assembly of FIG. 1 coupled with a surface controlled gas lift valve (“SCGLV”).

While subject matter is described in connection with embodiments disclosed herein, it will be understood that the scope of the present disclosure is not limited to any particular embodiment. On the contrary, it is intended to cover all alternatives, modifications, and equivalents thereof.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes +/−5% of a cited magnitude. In an embodiment, the term “substantially” includes +/−5% of a cited magnitude, comparison, or description. In an embodiment, usage of the term “generally” includes +/−10% of a cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

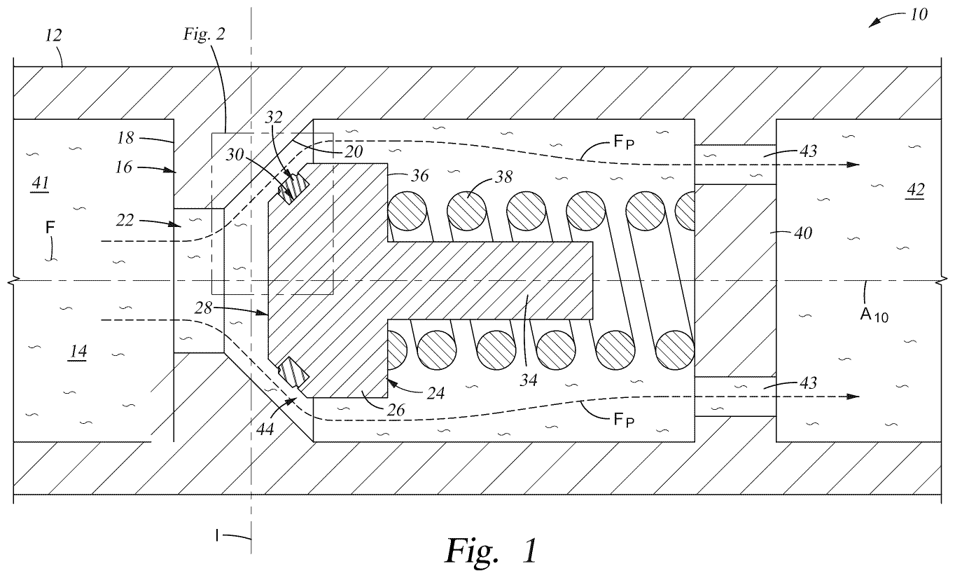

Shown in a side sectional view in FIG. 1 is an example of a valve assembly 10 that includes an outer housing 12, a passage 14 within housing 12 that extends along axis A₁₀ of valve assembly 10; and a valve seat 16 is formed within the housing 12. Valve seat 16 is a disk like member having an outer diameter attached along an inner circumference of housing 12. A forward surface 18 of valve seat 16 projects radially inward from sidewalls of the housing 12 and perpendicular with axis A₁₀. A rearward surface 20 of valve seat 16 is spaced axially away from forward surface 18 projects radially inward from sidewalls of housing 12 at an angle oblique with axis A₁₀ so that an axial thickness of valve seat 16 increases with distance away from axis A₁₀. The surfaces 18, 20 terminate within the passage 14 a distance away from axis A₁₀. An opening 22 is formed axially through valve seat 16 where surfaces 18, 20 terminate within passage 14, 22.

Valve assembly 10 also includes a valve member 24 shown in passage 14 and spaced just downstream of valve seat 16. Valve member 24 includes a disk-like plug head 26 having a front surface 28 that faces the rearward surface 20 of the valve seat 16. An outer radial portion of front surface 28 is profiled complementary to the rearward surface 20, and an annular recess 30 is shown formed within this profiled portion and circumscribing axis A₁₀. A ring 32 is disposed within recess 30. In an embodiment, ring 32 is formed from a compliant material, non-limiting examples of a compliant material include an elastomer, a thermoplastic, a material with a substantially lower modulus of elasticity than the surfaces against which it seals, and combinations. In alternatives, the material making up ring 32 has a modulus of elasticity that ranges up to about 0.1 GPa.

Still referring to FIG. 1, valve member 24 includes an elongate stem 34 shown attached to a back surface 36 of plug head 26, and which projects axially away from the plug head 26 in a direction opposite from the valve seat 16. Circumscribing stem 34 is a spring 38 that exerts a biasing force against back surface 36 urging valve member 24 towards valve seat 16. A substantially planar bulkhead 40 is shown spanning between sidewalls of housing 12 and oriented generally perpendicular to axis A₁₀. Spring 38 is compressed between back surface 36 and bulkhead 40. An interface I between the valve seat 16 and valve member 24 defines a boundary between upstream and downstream portions 41, 42 of passage 14. Axial ports 43 are formed through the bulkhead 40. In FIG. 1, the valve member 24 is spaced away from valve seat 16, and forms a gap 44 between front surface 28 and rearward surface 20. Fluid F is shown flowing from the upstream portion 41, through the gap 44 to the downstream portion 42, and through the apertures 43.

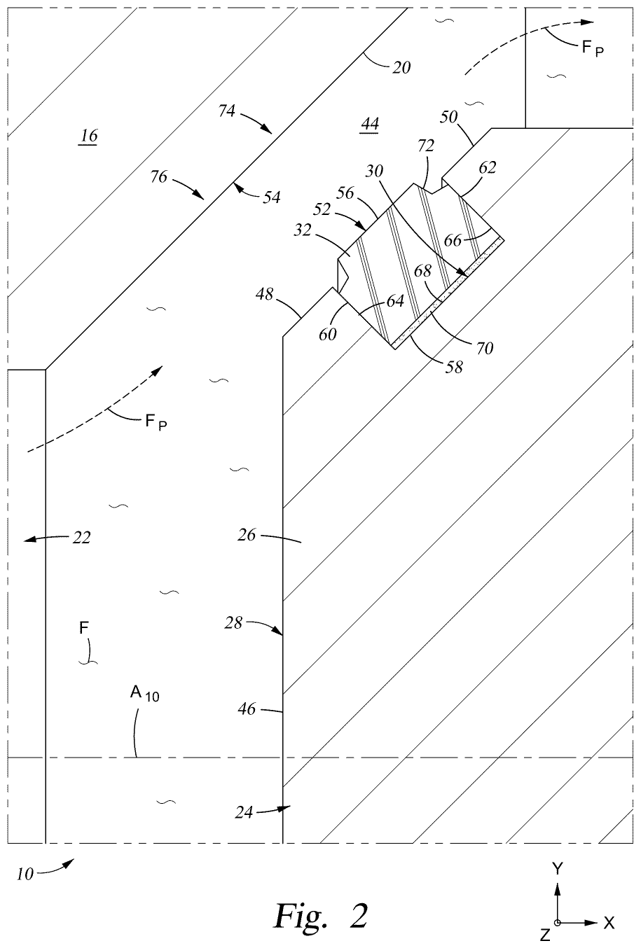

FIG. 2 is an enlarged side sectional view of a portion of the valve assembly 10 of FIG. 1, and includes an XYZ coordinate for convenience. In the illustrated example, the front surface 28 of plug head 26 includes a middle portion 46, an inner lateral portion 48, and an outer lateral portion 50. Middle portion 46 is intersected by and substantially perpendicular with axis A₁₀. Inner lateral portion 48 is between middle portion 46 and recess 30, and begins where front surface 28 transitions from being perpendicular to axis A₁₀ to being oblique to axis A₁₀. Outer lateral portion 50 is also generally oblique to axis A₁₀, and is on a side of recess 30 opposite inner lateral portion 48. A valve member seal face 52 is defined on the front surface of the valve member 26 facing the rearward surface 20 of the valve seat 16, and a valve seat seal face 54 is defined along the portion of the rearward surface 20 facing the seal face 52. Described below is that engaging faces 52, 54 together to form seal interface forms a barrier to the flow of fluid F between the valve seat 16 and valve member 24 and through the valve assembly 10. Further illustrated in the enlarged view of FIG. 2 is that the ring 32 includes a forward surface 56 shown protruding past surface 28 outside of the recess 30 and facing the rearward surface 20. When the valve member 24 is positioned away from the valve seat 16 so that the gap 44 extends between the forward surface 56 and rearward surface 20 to allow a flow of fluid F therebetween, the valve assembly 10 is in what is referred to as an open mode.

Ring 32 includes a rearward surface 58 on a side opposite the forward surface 56, an inner surface 60 along its inner radius, and an outer surface 62 along its outer radius. Recess 30 includes inner and outer sidewalls 64, 66 generally parallel to one another, and a rearward wall 68 that extends between terminal ends of the walls 64, 66. Inner and outer surfaces 60, 62 are adjacent inner and outer sidewalls 64, 66 respectively when ring 32 is in recess 30. Optionally, a bond 70 is between the rearward surface 58 of ring 32 with the rearward wall 68 of the recess 30, which provides a retaining force to secure ring 32 within the recess 30. Bond 70 optionally extends between surfaces 60, 62 and sidewalls 64, 66. In this alternative, the bond 70 allows enough respective movement between surfaces 60, 62 and sidewalls 64, 66 to avoid damaging shear stresses along surfaces 60, 62 when the ring 32 is compressed within recess 30, which reduces chances of shearing of the material making up the ring 32. A chamfer 72 formed along the forward surface 56 of ring 32, which forms a space in which the material of the ring 32 can flow when compressive or pressure forces are applied to the ring 32.

Still referring to FIG. 2, the portion of plug head 26 making up the inner lateral portion 48 is configured to form a metal-to-metal (“MTM”) seal face. In an example, at least the inner lateral portion 48 of plug head 26 is formed from a metal, such as carbon steel, stainless steel, brass, or an alloy. In an alternative, at least the inner lateral portion 48 of plug head 26 undergoes elastic deformation when forming the fluid barrier, and is optionally polished to designated surface finish. Similarly, at least the portion of the rearward surface 20 making up the valve seat seal face 54 is correspondingly polished and/or otherwise conditioned so that when in compressive engagement with the inner lateral portion 48, a MTM seal is formed between the valve seat 16 and valve member 24.

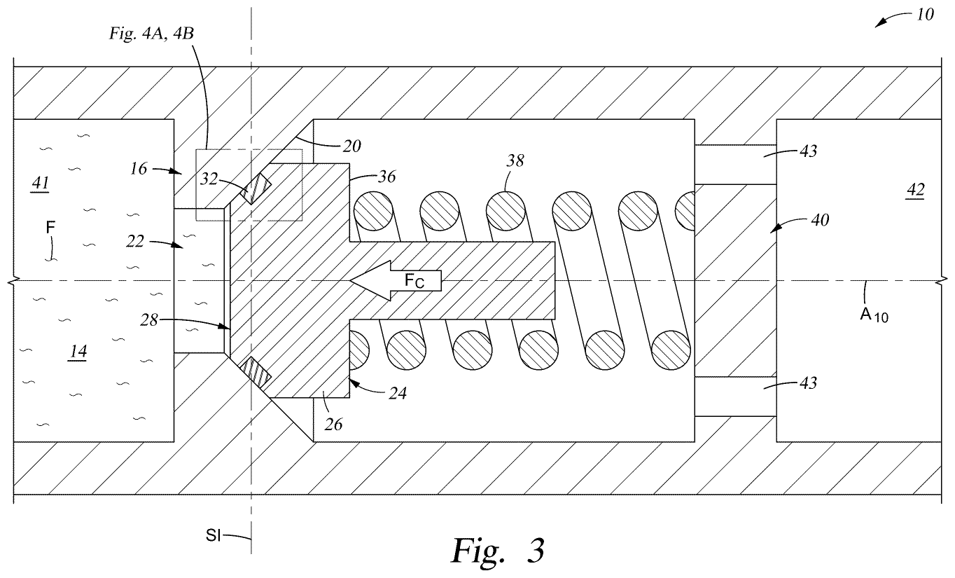

An example of the valve assembly 10 being in a closed mode shown in a side sectional view in FIG. 3. In this example, the valve member 24 is biased against the valve seat 16 by a force F_{C}, which urges seal faces 52, 54 (FIG. 2) together to form a sealing interface SI between the forward surface 28 and rearward surface 20. Sealing interface SI blocks fluid F in the upstream portion 41 from flowing between the valve member 24 and valve seat 16 and to downstream portion 42. Spring 38 is shown expanded from its configuration of FIG. 1 and biasing the valve member 24 against valve seat 16 with an applied spring force against the back surface 36. In examples, the flow of fluid F is suspended and pressures in portions 41, 42 are substantially equal so that the force F_{C} is solely from spring 38. Optionally, force F_{C} is from spring 38 and a pressure differential between portions 41, 42 to put valve assembly 10 into the closed mode and form the sealing interface S_{I}. In an alternative, force F_{C} is mechanically provided, such as from a hydraulic source or motor (not shown), and the position of valve member 24 with respect to valve seat 16 is selectively adjusted.

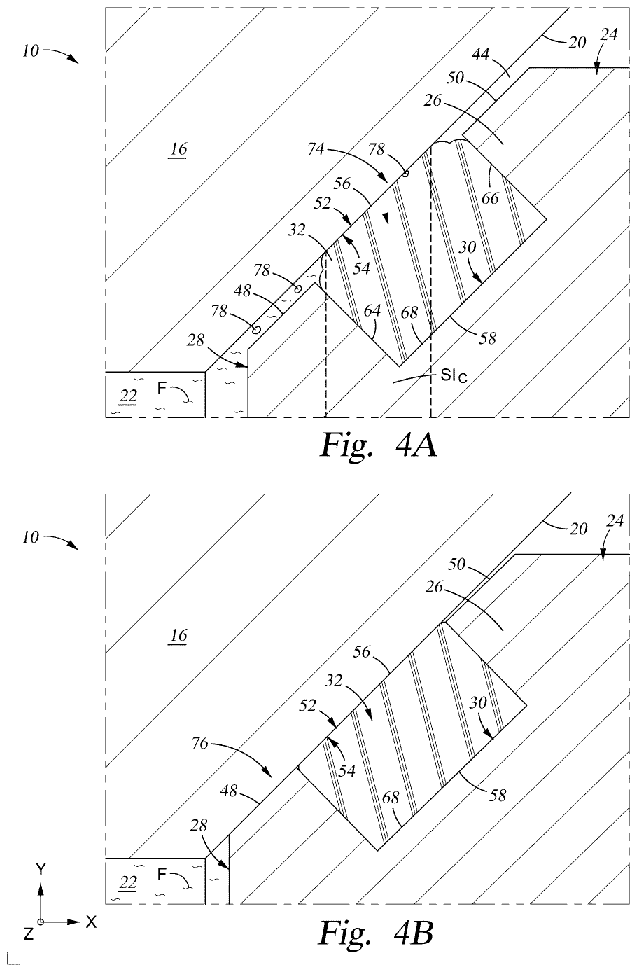

Shown in FIG. 4A is an enlarged cross-sectional view of an example of the valve assembly 10 in a first closed mode. In the first closed mode, the valve member 24 and valve seat 16 are at a designated distance from one another and closer together than in the open mode of FIG. 1 by an amount that brings forward surface 56 into contact with rearward surface 20 and compresses and elastically deforms ring 32 by an amount that forms a compliant sealing interface SI_{C} between valve seat 16 and valve member 24, which is a barrier to fluid flow in valve assembly 10. In the example of FIG. 4A, the valve member seal face 52 is defined along the forward surface 56 (FIG. 2) of ring 32, and the valve seat seal face 54 is defined along the area where the ring 32 is compressed against the rearward surface 20, and a compliant seal assembly 74 is formed by engaging seal faces 52, 54 as described above. Also shown in FIG. 4A is that the gap 44 remains between surface 20 and portions 48, 50 when the valve assembly 10 is in the first closed mode. In examples in which fluid F (FIG. 3) has particles 78 entrained within, the particles 78 are shown in the gap 44 and between seal faces 52, 54. In FIG. 4A, the ring 32 is configured so that when compressed the width of gap 44 exceeds the diameter of particle 78 to avoid deformation of portion 49 or surface 20 from contact with a particle 78.

FIG. 4B is an enlarged portion of the valve assembly 10 of FIG. 3, illustrating an example of the valve assembly 10 in a second closed mode, in which the valve member 24 and valve seat 16 are positioned so that portion 48 contacts surface 20, and are biased together with a force adequate to elastically deform portion 48 and surface 20 and create a MTM seal. In this example, the valve member seal face 52 is defined by the area of portion 48 that is elastically deformed by contact with surface 20, and the valve seat seal face 54 is defined by the area of surface 20 elastically deformed by contact with valve member seal face 52, and a non-compliant seal assembly 76 is formed by engaging seal faces 52, 54 of FIG. 4B as described above. In one embodiment, portion 50 is also configured to create an MTM seal, and the seal face 52 is formed on portion 48 and on portion 50. In alternatives, surface 28 is configured so that portion 50 is angled away from surface 20 and configured to not be in contact with surface 20.

In the example of FIG. 4B, the ring 32 is shown fully compressed within recess 30 and does not extend outside of recess 30. Optionally, the difference in pressure between the upstream and downstream portions 41, 42 (FIG. 3) is of an amount that fully compresses the ring 32 as shown in FIG. 4B so that the faces 52, 54 are brought into sealing contact with one another. In alternatives, after a period of time of use of the valve assembly 10 in a particular application, the ring 32 is no longer present in recess 30, either due to extrusion or erosion. An advantage of the present disclosure is that when a valve is put initially into use in a well, the fluid is more prone to contain particulate matter, which is generally not problematic for a compliant seal assembly, such as that in FIG. 4A. Over a period of time in which the elastomer or compliant seal within the valve assembly 10 erodes or is extruded away, the well fluid contains less particulate matter, and the use of an MTM seal is more appropriate and effective.

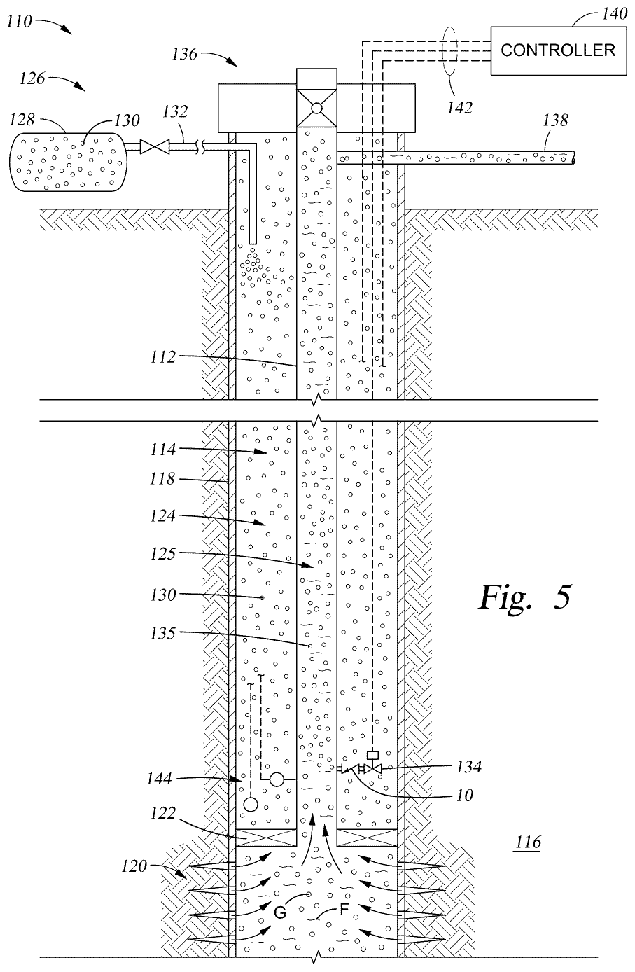

Shown in a side sectional view in FIG. 5 is an example of valve assembly 10 of FIG. 1 installed in a well system 110 that includes a string of production tubing 112 installed in a wellbore 114 shown formed into a subterranean formation 116. Casing 118 lines the wellbore 114, and perforations 120 project radially outward from the wellbore 114 through the casing 118 and into the surrounding formation 116. In this example, the perforations 120 provide a pathway for fluid F to flow into the wellbore 114 from the formation 116. In the example shown, the fluid F is made up primarily of liquid with some small bubbles of gas G mixed within. A packer 122 circumscribes a downhole end of tubing 112 to block the fluid F from flowing into an annulus 124 between the tubing 112 and casing 118. The fluid F instead flows into a bore 125 in the production tubing 112.

The well system 110 includes a lift gas system 126 for assisting the flow of the fluid F uphole within the bore 125 of production tubing 112. In the example of FIG. 5, the lift gas system 126 includes a lift gas source 128 shown on the surface, embodiments of lift gas source 128 include an adjacent well, a pipeline, or a vessel. Lift gas source 128 provides lift gas 130, which is shown being injected into the annulus 124 through an injection line 132. Lift gas 130 inside injection line 132 is at a designated pressure so that the lift gas 130 is forced downhole within annulus 124 to a surface controlled gas lift valve (“SCGLV”) 134 in the annulus 124. An end of valve assembly 10 connects to SCGLV 134, and an opposite end of valve assembly connects to a port formed through a sidewall of the tubing 112. SCGLV 134 is intermittently opened to allow a flow of lift gas 130 from the annulus 124 through the open SCGLV 134 to the valve assembly 10. When a pressure differential between the annulus 124 and bore 125 generates a force exceed a spring constant of spring 36 (FIG. 1), the valve member 24 is moved away from valve seat 16 to allow lift gas 130 to flow past the valve member 24 into the bore 125 of production tubing 112 where it forms bubbles 135 of lift gas 130 inside the fluid F. In alternatives, fluid F is referred to as a produced fluid and the lift gas 130 is referred to as a secondary fluid. The lower density bubbles 135 reduce the density of the fluid F to assist the flow of fluid F uphole inside bore 125 and to a wellhead assembly 136 shown mounted over the wellbore 114 and connected to an end of production tubing 112. Inside wellhead assembly 136, the fluid F is directed to a production line 38 shown attached to a lateral side of wellhead assembly 136. Inside production line 138, fluid F is carried to a location that is offsite for transportation or to a processing facility (not shown). In the example of FIG. 5, a controller 140 is schematically illustrated outside of wellbore 114 and in signal communication with the SCGLV 134 via communication means 142. Examples of communication means 142 include electrically conducting wire, fiber optics, hydraulics, and wireless, such as telemetry. Further optionally included are sensors 144 that are in temperature and pressure communication with annulus 124 and/or bore 125, and which transmit downhole conditions to controller 140 via communication means 142.

Advantages of the valve assembly disclosed herein is that employing a compliant seal assembly allows for a sealing level of V0 as defined in API 19G2, which is not obtained with non-compliant materials in MTM seals when utilizing only a line seal (as required without substantial preload). The elastomeric seal also protects the MTM seal from damage. Even if there is temporary debris holding the MTM seal off seat, the compliant seal will block flow and avert erosion on the MTM seal surface. There is typically less debris flowing later in the well's life, so if the compliant material degrades it has still served to protect the MTM sealing surface from debris and its deleterious effects.

An optional bonded sealing system offers an additional advantage over an elastomer or thermoplastic. It holds the seal in place regardless of opening with slight differential or high-flow scenarios. Utilizing a bonded seal in a check valve eliminates the complication from some scenarios when pressure must be applied from both directions, as pressure differential is held in one direction in a check valve. Though the compliant seal system can degrade over time and with cycles, the MTM sealing system will remain intact over the life of the well.

Non-limiting examples of a compliant material include elastomer, thermoplastic, material with a substantially lower modulus of elasticity i.e., up to about 0.1 GPa (e.g., about 1.45×10⁴ pounds per square inch) than the surfaces against which it seals, and combinations. Examples of non-compliant materials include materials having a modulus of elasticity of at least about 700 GPa (e.g., about 10×10⁷ pounds per square inch or greater) such that little deformation is used to make a seal. In examples, MTM seals, carbide to metal seals, and carbide to carbide seals have opposing seal surfaces of non-compliant material that creates a line seal, i.e., two surfaces that make a line at their point of intersection (or a point when viewing the cross section of the assembly) would be a line seal. In contrast, a sealing system with materials one of which has a low modulus or in which there is plastic deformation, a theoretical cross section of the surfaces sealing would show a contact patch rather than a point.

Alternatives include that the disclosed seal assembly is used as an actuated seal, the compliant seal (ring 32) is coupled with a valve seat instead of a valve member, valve member embodiments include a ball, a plug, and a dart. Additional applications of the present disclosure include use in wells with one or more of water, gas, CO₂ injection, or chemical injection. Optional locations of the valve assembly includes in line with the flow control valve in surface controlled gas lift valves to block fluid inside the production tubing from flowing to outside the production tubing.

The present invention described herein, therefore, is well adapted to carry out the objects and attain the ends and advantages mentioned, as well as others inherent therein. While one or more embodiments have been given for purposes of disclosure, numerous changes exist in the details of procedures for accomplishing the desired results. These are intended to be encompassed within the spirit of the present invention disclosed herein and the scope of the appended claims.

What is claimed is.

1. A valve assembly for handling fluid flow comprising:
a valve seat comprising a valve seat seal face;
a valve member;
a pliable ring that when compressed between the valve seat and valve member forms a compliant seal assembly that is a barrier to fluid flow through the valve assembly;
a valve member seal face that when in compressive contact with the valve seat seal face forms a non-compliant seal assembly that is a barrier to fluid flow through the valve assembly; and
a valve body in which the valve member and valve seat are disposed.

2. The valve assembly of claim 1, wherein the ring is disposed in an annular recess formed on the valve body, wherein the recess comprises an inner sidewall, an outer sidewall, and a rearward wall extending radially between rearward terminal ends of the inner and outer sidewalls.

3. The valve assembly of claim 2, wherein an inner radius of the pliable ring is adjacent to and moveable with respect to the inner sidewall, an outer radius of the pliable ring is adjacent to and moveable with respect to the outer sidewall, and wherein a rearward surface of the pliable ring is bonded to the rearward wall.

4. The valve assembly of claim 1, wherein a chamfer is on a radial edge of a forward surface of the pliable ring.

5. The valve assembly of claim 1, wherein the pliable ring comprises an elastomer with a modulus of elasticity of up to about 0.1 GPa.

6. The valve assembly of claim 1, wherein the seal faces comprise polished metal having a modulus of elasticity that ranges from about 35 GPa to about 700 Gpa.

7. The valve assembly of claim 1, wherein the valve member comprises a plug that is biased towards the valve seat by a spring.

8. The valve assembly of claim 1, wherein the valve assembly is changeable between an open mode, a first closed mode, and a second closed mode, wherein when in the open mode a gap is between the valve member and valve seat that defines a flow path, wherein when in the first closed mode the pliable ring is compressed between the valve seat and valve member and the valve member seal face is spaced away from the valve seat seal face, and when in the second closed mode the valve member seal face is compressed against the valve seat seal face.

9. The valve assembly of claim 8, wherein when in the first closed mode a seal is formed between the valve member and valve seat that is bubble tight.

10. The valve assembly of claim 1, wherein the valve body is connected between a surface controlled flow control valve and production tubing that are disposed in a wellbore.

11. A valve assembly for handling fluid flow comprising:
a valve seat having a valve seat seal face;
a valve member having a valve member seal face;
a compliant seal formed between the valve seat and valve member when the valve seat and valve member are at a designated distance from one another;
a non-compliant seal formed between the valve seat and valve member when the seal faces are in contact with one another; and
a valve body in which the valve member and valve seat are disposed.

12. The valve assembly of claim 11, wherein the compliant seal comprises a ring mounted to one of the valve seat or valve member, and wherein the ring is formed from a that is material elastically compressive.

13. The valve assembly of claim 12, wherein the ring is in an annular recess formed on the valve member, wherein a forward surface of the ring projects past a front surface of the valve member, and wherein a chamfer is formed along an edge of the forward surface to define a space that receives a portion of the ring when the ring is compressed.

14. The valve assembly of claim 11, wherein the non-compliant seal is a metal-to-metal (“MTM”) seal.

15. The valve assembly of claim 11, wherein the valve assembly comprises a check valve connected between a surface controlled flow control valve and production tubing that are disposed in a wellbore, and wherein the surface controlled flow control valve is part of a lift gas system.

16. A method of handling fluid flow comprising:
obtaining a valve assembly comprising a valve body, a valve member, a valve seat, a compliant seal assembly, and a non-compliant seal assembly;
arranging the valve assembly into an open mode by creating a gap between the valve body and valve member, which forms a fluid flow path between the valve body and valve member and allows fluid to flow through the valve assembly;
arranging the valve assembly into a first closed mode by urging the valve body and valve member to a distance from one another that compresses and elastically deforms the compliant seal assembly between the valve body and valve member; and
arranging the valve assembly into a second closed mode by urging the valve body and valve member against one another that compresses and elastically deforms seal faces formed on the valve body and the valve member.

17. The method of claim 16, wherein the step of arranging the valve assembly into the first closed mode occurs for a period of time, and wherein the step of arranging the valve assembly into the second closed mode occurs after the period of time, and wherein during the period of time particles are included with the fluid flowing through the valve assembly.

18. The method of claim 17, wherein the compliant seal comprises an elastomeric ring mounted to the valve member and wherein the non-compliant seal comprises polished seal faces on opposing surfaces of the valve member and valve seat.

19. The method of claim 18, wherein fluid leakage through the valve assembly is blocked by the compliant seal for the period of time, and wherein fluid leakage through the valve assembly is blocked by the non-compliant seal after the period of time.
